(19) United States
(12) Patent Application Publication
(10) Pub. No.: US 2024/0001620 A1
(43) Pub. Date: Jan. 4, 2024

(54) METHOD FOR MANUFACTURING THREE-DIMENSIONAL SHAPED OBJECT, THREE-DIMENSIONAL SHAPING SYSTEM, AND INFORMATION PROCESSING DEVICE

(71) Applicant: SEIKO EPSON CORPORATION, Tokyo (JP)

(72) Inventor: Satoshi YAMAZAKI, MATSUMOTO-SHI (JP)

(21) Appl. No.: 18/343,583

(22) Filed: Jun. 28, 2023

(30) Foreign Application Priority Data
Jun. 30, 2022 (JP) 2022-105346

(51) Int. Cl. B29C 64/393; B29C 64/118; B29C 64/40; B33Y 10/00

(52) U.S. Cl. CPC B29C 64/393; B29C 64/118; B29C 64/40; B33Y 10/00; B33Y 50/02

(57) ABSTRACT

There is provided a method for manufacturing a three-dimensional shaped object in which a shaped object and a support structure that supports the shaped object are shaped by ejecting a material to laminate a layer in a laminating direction. The manufacturing method includes: a first step of shaping, based on support data generated according to a shaping condition, a support structure including a first support layer in contact with the shaped object from below and a second support layer in contact with the shaped object from above; and a second step of separating the first support layer and the second support layer from the shaped object. The shaping condition includes a shaping pattern selected from a plurality of shaping patterns, and data for shaping the first support layer and data for shaping the second support layer among the support data are generated based on the different shaping conditions.

The present application is based on, and claims priority from JP Application Serial Number 2022-105346, filed Jun. 30, 2022, the disclosure of which is hereby incorporated by reference herein in its entirety.

### BACKGROUND

### 1. Technical Field

The present disclosure relates to a method for manufacturing a three-dimensional shaped object, a three-dimensional shaping system, and an information processing device.

### 2. Related Art

In relation to a method for manufacturing a three-dimensional shaped object, JP-A-2021-511990 discloses that a second layer structure is formed on a first layer structure and a support structure, and then the support structure is removed to form an overhang structure.

In the method for manufacturing a three-dimensional shaped object, as described in JP-A-2021-511990, the support structure that supports the shaped object is shaped below the shaped object, so that shape deformation of the shaped object can be prevented and the shaped object can be accurately shaped. However, the inventors of the present application have found a problem that it is difficult to achieve both shaping accuracy of the shaped object and peelability of the support structure from the shaped object when shaping the support structures in contact with the shaped object from above and below, separately.

### SUMMARY

According to a first aspect of the present disclosure, a method for manufacturing a three-dimensional shaped object, in which a shaped object and a support structure that supports the shaped object are shaped by ejecting a material to laminate a layer in a laminating direction, is provided. The manufacturing method includes: a first step of shaping, based on support data generated according to a shaping condition, the support structure including a first support layer in contact with the shaped object from below and a second support layer in contact with the shaped object from above; and a second step of separating the first support layer and the second support layer from the shaped object. The shaping condition includes a shaping pattern selected from a plurality of shaping patterns. Data for shaping the first support layer and data for shaping the second support layer among the support data are generated based on the different shaping conditions.

According to a second aspect of the present disclosure, a three-dimensional shaping system is provided. The three-dimensional shaping system includes: a shaping unit configured to shape, by ejecting a material to laminate a layer in a laminating direction, a shaped object and a support structure that supports the shaped object; and a control unit configured to control the shaping unit to shape a first support layer in contact with the shaped object from below, a second support layer in contact with the shaped object from above, and the shaped object based on support data generated according to a shaping condition. The shaping condition includes a shaping pattern selected from a plurality of shaping patterns. Data for shaping the first support layer and data for shaping the second support layer among the support data are generated based on the different shaping conditions.

According to a third aspect of the present disclosure, an information processing device is provided that generates support data used in a three-dimensional shaping device that shapes, by ejecting a material to laminate a layer in a laminating direction, a shaped object and a support structure that supports the shaped object.

The information processing device includes: a data generation unit configured to generate, according to a shaping condition, the support data for shaping a first support layer in contact with the shaped object from below and a second support layer in contact with the shaped object from above. The shaping condition includes a shaping pattern selected from a plurality of shaping patterns. The data generation unit is configured to generate, based on the different shaping conditions, data for shaping the first support layer and data for shaping the second support layer among the support data.

### BRIEF DESCRIPTION OF THE DRAWINGS

FIG. 1 is a diagram showing a schematic configuration of a three-dimensional shaping system.

FIG. 2 is a perspective view showing a schematic configuration of a flat screw.

FIG. 3 is a schematic plan view of a barrel.

FIG. 4 is a diagram schematically showing a state where a three-dimensional shaping device shapes a shaped object.

FIG. 5 is a diagram showing a schematic configuration of an information processing device.

FIG. 6 is a flowchart of a shaping process.

FIG. 7 is a diagram showing an example of a setting screen for setting a shaping condition.

FIG. 8 is a diagram showing an example of a shaped object and a support structure.

FIG. 9 is a diagram showing an example of a shaping pattern.

FIG. 10 is a diagram showing a filling rate.

FIG. 11 is a diagram showing an example of visualizing shaping data.

FIG. 12 is a diagram showing an example of a first support layer having a portion in contact with the shaped object and a second support layer not in contact with the shaped object.

### DESCRIPTION OF EXEMPLARY EMBODIMENTS

### A. First Embodiment

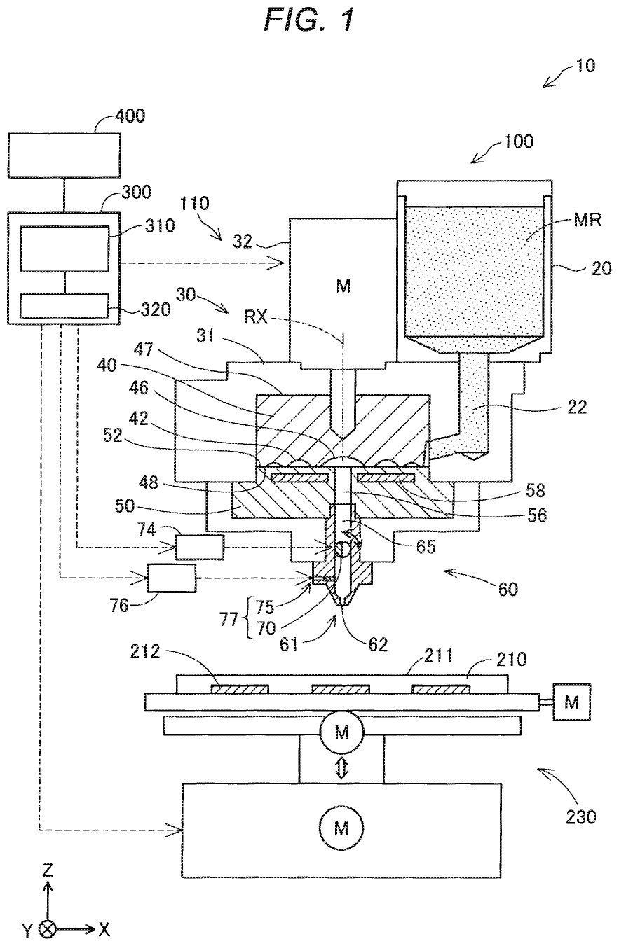

FIG. 1 is a diagram showing a schematic configuration of a three-dimensional shaping system 10 according to a first embodiment. In FIG. 1, arrows indicating X, Y, and Z directions orthogonal to each other are shown. The X direction and the Y direction are directions parallel to a horizontal plane, and the Z direction is a direction along a vertically upward direction. The arrows indicating the X, Y, and Z directions are also shown in other drawings as appropriate so that the directions shown in the drawings correspond to those in FIG. 1. In the following description, when a direction is specified, a direction indicated by an arrow in each drawing is referred to as “+”, a direction opposite thereto is referred to as “−”, and a positive or negative sign is used in combination with a direction notation. Hereinafter, a +Z direction is also referred to as “upper”. A −Z direction is also referred to as “lower”.

The three-dimensional shaping system 10 includes a three-dimensional shaping device 100 and an information processing device 400. The three-dimensional shaping device 100 according to the present embodiment is a device that shapes a shaped object by a material extrusion method. The three-dimensional shaping device 100 includes a control unit 300 that controls units of the three-dimensional shaping device 100. The control unit 300 and the information processing device 400 are communicably coupled to each other.

The three-dimensional shaping device 100 includes a shaping unit 110 that generates and ejects a shaping material, a shaping stage 210 serving as a base of a shaped object, and a moving mechanism 230 that controls an ejection position of the shaping material.

The shaping unit 110 ejects a shaping material obtained by plasticizing a material in a solid state onto the stage 210 under the control of the control unit 300. The shaping unit 110 includes a material supply unit 20 that is a supply source of a raw material before being converted into the shaping material, a plasticizing unit that converts the raw material into the shaping material, and an ejection unit 60 that ejects the shaping material.

The material supply unit 20 supplies a raw material MR to the plasticizing unit 30. The material supply unit 20 includes, for example, a hopper that accommodates the raw material MR. The material supply unit 20 is coupled to the plasticizing unit 30 via a communication path 22. The raw material MR is put into the material supply unit 20 in a form of pellets, powder, or the like. In the present embodiment, a pellet-shaped ABS resin material is used.

The plasticizing unit 30 plasticizes the raw material MR supplied from the material supply unit 20 to generate a paste-shaped shaping material exhibiting fluidity, and guides the shaping material to the ejection unit 60. In the present embodiment, the term “plasticization” is a concept including melting, and is a change from a solid state to a fluid state. Specifically, in a case of a material in which a glass transition occurs, the plasticization is to raise a temperature of the material to be equal to or higher than a glass transition point. In a case of a material in which the glass transition does not occur, the plasticization is to raise a temperature of the material to be equal to or higher than a melting point.

The plasticizing unit 30 includes a screw case 31, a driving motor 32, a flat screw 40, and a barrel 50. The flat screw 40 is also referred to as a rotor or a scroll. The barrel 50 is also referred to as a screw facing portion.

The flat screw 40 is accommodated in the screw case 31. An upper surface 47 of the flat screw 40 is coupled to the driving motor 32, and the flat screw 40 is rotated in the screw case 31 by a rotational driving force generated by the driving motor 32. The driving motor 32 is driven under the control of the control unit 300. The flat screw 40 may be driven by the driving motor 32 via a speed reducer.

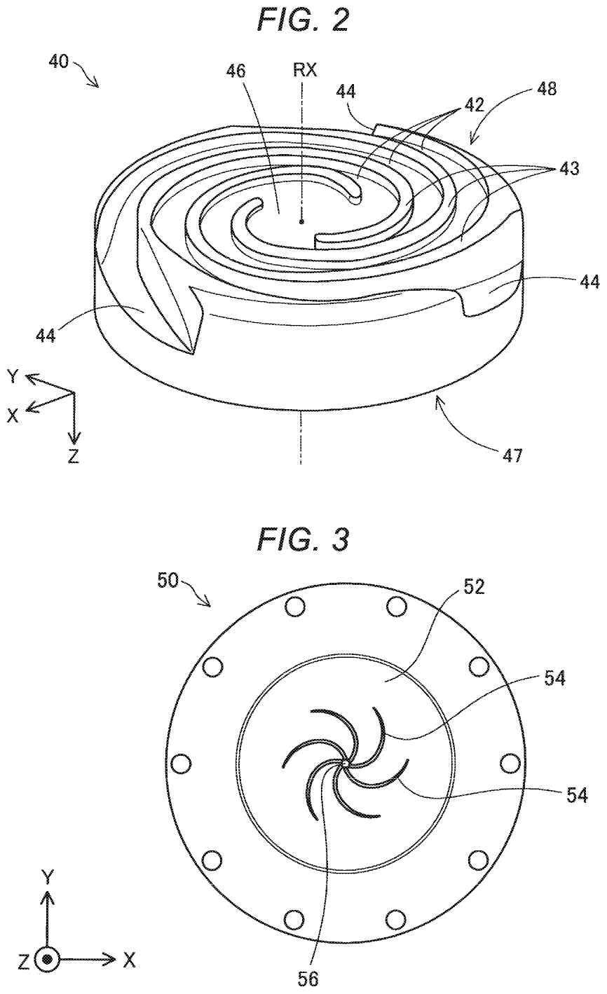

FIG. 2 is a perspective view showing a schematic configuration of the flat screw 40 on a lower surface 48 side. In order to facilitate understanding of the technique, the flat screw 40 shown in FIG. 2 is shown in a state where a positional relationship between the upper surface 47 and the lower surface 48 shown in FIG. 1 is reversed in a vertical direction. The flat screw 40 has a substantially columnar shape in which a length in an axial direction which is a direction along a central axis of the flat screw 40 is smaller than a length in a direction perpendicular to the axial direction. The flat screw 40 is disposed such that a rotation axis RX serving as a rotation center of the flat screw 40 is parallel to the Z direction.

Spiral groove portions 42 are formed on the lower surface 48 of the flat screw 40 which is a surface intersecting with the rotation axis RX. The communication path 22 of the material supply unit 20 communicates with the groove portions 42 from a side surface of the flat screw 40. In the present embodiment, three groove portions 42 are formed by being separated by ridge portions 43. The number of groove portions 42 is not limited to three, and may be one or two or more. A shape of the groove portion 42 is not limited to a spiral shape, may be a helical shape or an involute curve shape, or may be a shape extending in a manner of drawing an arc from a central portion toward an outer periphery.

As shown in FIG. 1, the lower surface 48 of the flat screw 40 faces an upper surface 52 of the barrel 50, and a space is formed between the groove portion 42 of the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 2.

A barrel heater 58 for heating the raw material MR supplied into the groove portion 42 of the rotating flat screw 40 is embedded in the barrel 50. A communication hole 56 is provided at a center of the barrel 50.

FIG. 3 is a schematic plan view showing an upper surface 52 side of the barrel 50. A plurality of guide grooves 54 coupled to the communication hole 56 and extending spirally from the communication hole 56 toward the outer periphery are formed in the upper surface 52 of the barrel 50. One end of the guide groove 54 may not be coupled to the communication hole 56. The guide groove 54 may be omitted.

The raw material MR supplied into the groove portions 42 of the flat screw 40 flows along the groove portions 42 by the rotation of the flat screw 40 while being plasticized in the groove portions 42, and is guided to a central portion 46 of the flat screw 40 as the shaping material. The paste-shaped shaping material that flows into the central portion 46 and exhibits fluidity is supplied to the ejection unit 60 via the communication hole 56 provided at a center of the barrel 50. In the shaping material, not all types of substances constituting the shaping material may be plasticized. The shaping material may be converted into a state having the fluidity as a whole by plasticizing at least some types of substances among the substances constituting the shaping material.

The ejection unit 60 in FIG. 1 includes a nozzle 61 that ejects the shaping material, a shaping material flow path 65 provided between the flat screw 40 and a nozzle opening 62, and an ejection control unit 77 that controls ejection of the shaping material.

The nozzle 61 is coupled to the communication hole 56 of the barrel 50 through the flow path 65. The nozzle 61 ejects the shaping material generated in the plasticizing unit 30 from the nozzle opening 62 at a tip end toward the stage 210.

The ejection control unit 77 includes an ejection adjustment unit 70 that opens and closes the flow path 65, and a suction unit 75 that sucks and temporarily stores the shaping material.

The ejection adjustment unit 70 is provided in the flow path 65, and changes an opening degree of the flow path 65 by rotating in the flow path 65. In the present embodiment, the ejection adjustment unit 70 is implemented by a butterfly valve. The ejection adjustment unit 70 is driven by a first driving unit 74 under the control of the control unit 300. The first driving unit 74 is implemented by, for example, a stepping motor. The control unit 300 can adjust a flow rate of the shaping material flowing from the plasticizing unit 30 to the nozzle 61, that is, an ejection amount of the shaping material ejected from the nozzle 61, by controlling a rotation angle of the butterfly valve using the first driving unit 74. The ejection adjustment unit 70 can adjust the ejection amount of the shaping material and can control ON/OFF of outflow of the shaping material.

The suction unit 75 is coupled between the ejection adjustment unit 70 in the flow path 65 and the nozzle opening 62. The suction unit 75 temporarily sucks the shaping material in the flow path 65 when the ejection of the shaping material from the nozzle 61 is stopped, thereby preventing a tailing phenomenon in which the shaping material drips from the nozzle opening 62 like pulling a thread. In the present embodiment, the suction unit 75 includes a plunger. The suction unit 75 is driven by a second driving unit 76 under the control of the control unit 300. The second driving unit 76 is implemented by, for example, a stepping motor, and a rack-and-pinion mechanism that converts a rotational force of the stepping motor into a translational motion of a plunger.

The stage 210 is disposed at a position facing the nozzle opening 62 of the nozzle 61. In the first embodiment, a shaping surface 211 of the stage 210 facing the nozzle opening 62 of the nozzle 61 is disposed to be parallel to the X and Y directions, that is, the horizontal direction. The stage 210 is provided with a stage heater 212 for preventing rapid cooling of the shaping material ejected onto the stage 210. The stage heater 212 is controlled by the control unit 300.

The moving mechanism 230 changes a relative position between the stage 210 and the nozzle 61 under the control of the control unit 300. In the present embodiment, a position of the nozzle 61 is fixed, and the moving mechanism 230 moves the stage 210. The moving mechanism 230 is implemented by a three-axis positioner that moves the stage 210 in three-axial directions of X, Y, and Z directions by driving forces of three motors. In the present description, unless otherwise specified, a movement of the nozzle 61 means moving the nozzle 61 or the ejection unit 60 with respect to the stage 210.

In another embodiment, instead of a configuration in which the stage 210 is moved by the moving mechanism 230, a configuration in which the moving mechanism 230 moves the nozzle 61 with respect to the stage 210 in a state where the position of the stage 210 is fixed may be adopted. A configuration in which the moving mechanism 230 moves the stage 210 in the Z direction and moves the nozzle 61 in the X and Y directions, or a configuration in which the moving mechanism 230 moves the stage 210 in the X and Y directions and moves the nozzle 61 in the Z direction may be adopted. With these configurations, a relative positional relationship between the nozzle 61 and the stage 210 can be changed.

The control unit 300 is a control device that controls an overall operation of the three-dimensional shaping device 100. The control unit 300 is implemented by a computer including one or a plurality of processors 310, a storage device 320 including a main storage device and an auxiliary storage device, and an input and output interface that receives and outputs a signal from and to the outside. By executing a program stored in the storage device 320, the processor 310 controls the shaping unit 110 and the moving mechanism 230 according to shaping data acquired from the information processing device 400 to shape a shaped object on the stage 210. Instead of being implemented by the computer, the control unit 300 may be implemented by a configuration in which circuits are combined.

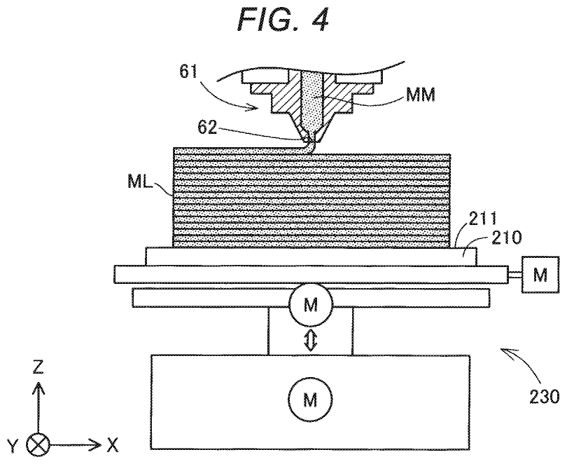

FIG. 4 is a diagram schematically showing a state where the three-dimensional shaping device 100 shapes a shaped object. In the three-dimensional shaping device 100, as described above, the solid raw material MR is plasticized to generate a shaping material MM. The control unit 300 keeps a distance between the shaping surface 211 of the stage 210 and the nozzle 61 and ejects the shaping material MM from the nozzle 61 while changing the position of the nozzle 61 with respect to the stage 210 in a direction along the shaping surface 211 of the stage 210. The shaping material MM ejected from the nozzle 61 is continuously deposited in a moving direction of the nozzle 61.

The control unit 300 forms a layer ML by repeating the movement of the nozzle 61. After one layer ML is formed, the control unit 300 relatively moves the position of the nozzle 61 with respect to the stage 210 in the Z direction. Then, a layer ML is further laminated on the layer ML formed so far to shape the shaped object.

For example, the control unit 300 may temporarily interrupt the ejection of the shaping material from the nozzle 61 when the nozzle 61 is moved in the Z direction after one layer ML is completely formed or when there are a plurality of independent shaping regions in each layer. In this case, the flow path 65 is closed by the ejection adjustment unit 70, the ejection of the shaping material MM from the nozzle opening 62 is stopped, and the shaping material in the nozzle 61 is temporarily sucked by the suction unit 75. After changing the position of the nozzle 61, the control unit 300 causes the ejection adjustment unit 70 to open the flow path 65 while discharging the shaping material in the suction unit 75, thereby resuming deposition of the shaping material MM from the changed position of the nozzle 61.

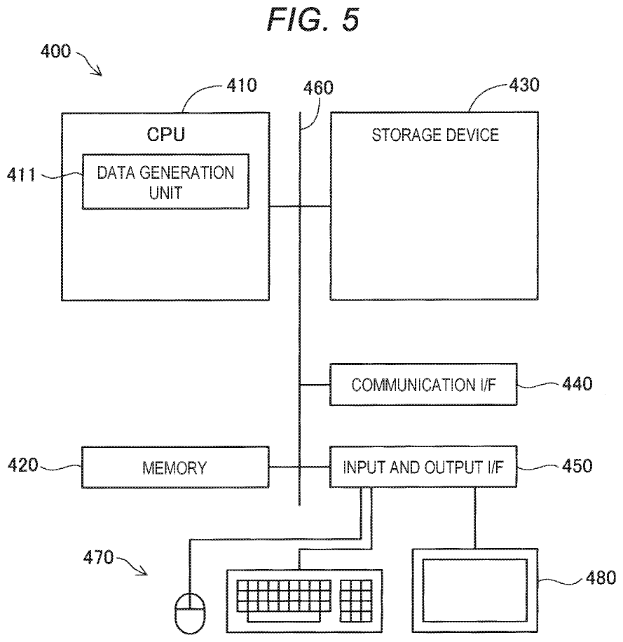

FIG. 5 is a diagram showing a schematic configuration of the information processing device 400. The information processing device 400 is implemented as a computer in which a CPU 410, a memory 420, a storage device 430, a communication interface 440, and an input and output interface 450 are coupled to one another by a bus 460. An input device 470 such as a keyboard and a mouse and a display device 480 such as a liquid crystal display are coupled to the input and output interface 450. The information processing device 400 is coupled to the control unit 300 of the three-dimensional shaping device 100 via the communication interface 440.

The CPU 410 functions as a data generation unit 411 by executing a program stored in the storage device 430.

The data generation unit 411 generates support data for shaping a support structure including a first support layer in contact with the shaped object from below and a second support layer in contact with the shaped object from above. The data generation unit 411 generates, based on different shaping conditions, data for shaping the first support layer and data for shaping the second support layer among the support data. In the present embodiment, the data generation unit 411 also generates main body data for shaping a shaped object main body in addition to the support data.

The information processing device 400 transmits shaping data including the main body data and the support data generated by the data generation unit 411 to the control unit 300 of the three-dimensional shaping device 100. The control unit 300 controls the ejection unit 60 and the moving mechanism 230 according to the received shaping data to eject the material and laminate a layer in a laminating direction, thereby shaping, on the stage 210, a shaped object and a support layer that supports the shaped object.

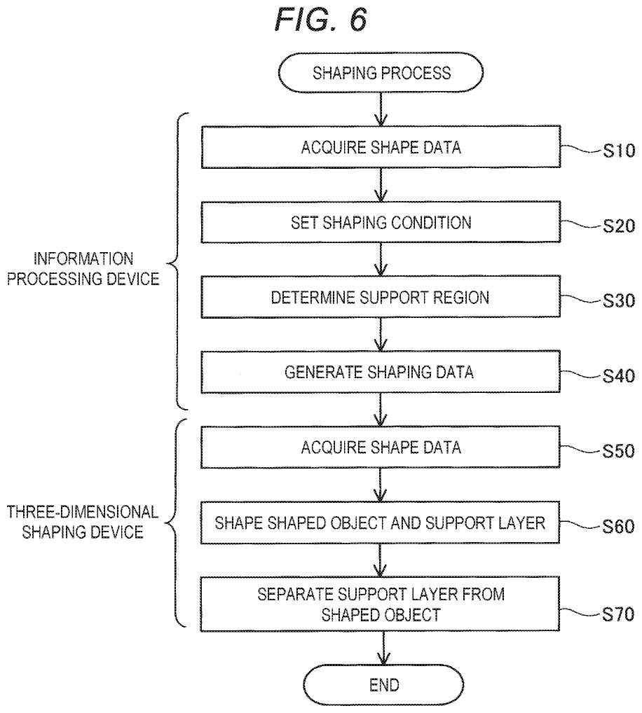

FIG. 6 is a flowchart of a shaping process executed in the three-dimensional shaping system 10. The shaping process is a process for implementing the method for manufacturing a three-dimensional shaped object. Processes of steps S10 to S40 shown in FIG. 6 are executed in the information processing device 400, and processes of steps S50 to S70 are executed in the three-dimensional shaping device 100.

In step S10, the data generation unit 411 of the information processing device acquires shape data representing a three-dimensional shape of the shaped object from another computer, a recording medium, or the storage device 430. The shape data is data representing a shape of a three-dimensional shaped object created using three-dimensional CAD software, three-dimensional CG software, or the like. As the shape data, for example, data in an STL format or an AMF format can be used.

In step S20, the data generation unit 411 receives setting of shaping conditions related to the support structure from a user. The user operates a setting screen displayed on the display device 480 using the input device 470 to set the shaping conditions.

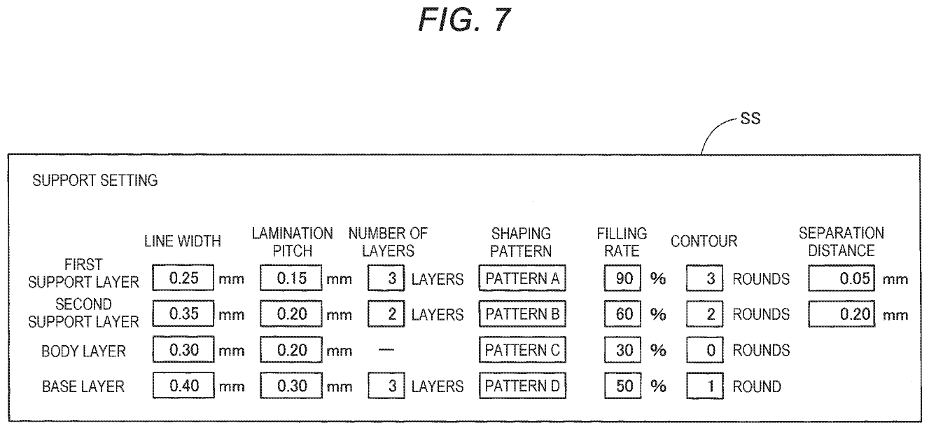

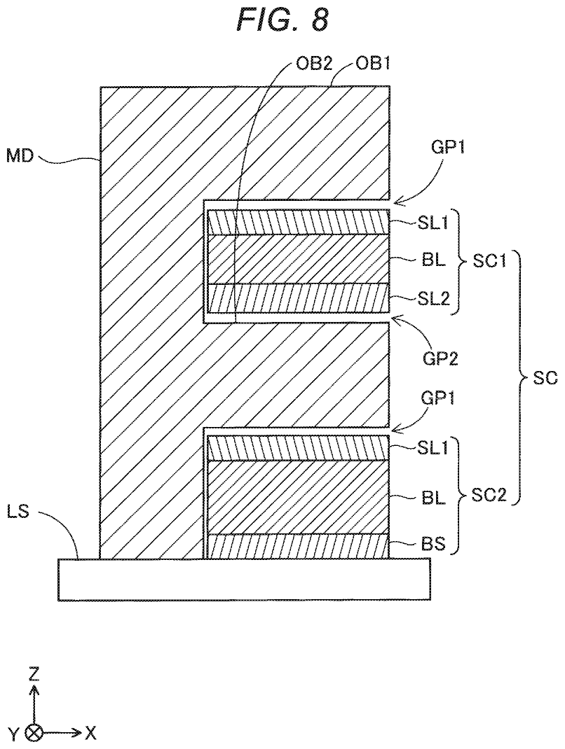

FIG. 7 is a diagram showing an example of a setting screen SS for setting the shaping conditions. FIG. 8 is a diagram showing an example of a shaped object MD and a support structure SC. FIG. 8 shows a shape of the shaped object representing a letter “F” of the alphabet as a shape of the shaped object MD. In the example shown in FIG. 8, the support structure SC includes a first support structure SC1 and a second support structure SC2. The first support structure SC1 is disposed in a region between a first overhang portion OB1 and a second overhang portion OB2 of the shaped object MD. The second support structure SC2 is disposed in a region between the second overhang portion of the shaped object MD and the lowermost surface LS corresponding to the shaping surface 211 of the stage 210. The overhang portion refers to a projection portion of the shaped object which is not supported below.

The first support structure SC1 includes a first support layer SL1, a body layer BL, and a second support layer SL2. The first support layer SL1 is a layer in contact with the shaped object MD from below. The second support layer SL2 is a layer in contact with the shaped object MD from above. The body layer BL is a layer sandwiched between the first support layer SL1 and the second support layer SL2. The second support structure SC2 includes the first support layer SL1, the body layer BL, and a base layer BS. The base layer BS is in contact with the lowermost surface LS. The body layer BL of the second support structure SC2 is a layer sandwiched between the first support layer SL1 and the base layer BS. It can also be said that the first support layer SL1 is a layer in contact with the shaped object MD above the body layer BL. It can also be said that the second support layer SL2 is a layer in contact with the shaped object MD below the body layer BL.

On the setting screen SS shown in FIG. 7, for the first support layer SL1, the second support layer SL2, the body layer BL, and the base layer BS, items for setting a line width, a lamination pitch, the number of layers, a shaping pattern, a filling rate, the number of rounds of contour, and a separation distance are provided as the shaping conditions.

The “line width” is an item for designating a width of the shaping material ejected from the nozzle 61.

The “lamination pitch” is an item for designating a height of each layer.

The “number of layers” is an item for designating the number of layers constituting each of the first support layer SL1, the second support layer SL2, and the base layer BS.

The “shaping pattern” is an item for designating a pattern indicating a movement path of the nozzle 61 for filling an interior region of each layer.

The “filling rate” is an item for designating an area ratio of filling the interior region with the designated shaping pattern.

The number of rounds of “contour” is an item for designating the number of rounds for forming a contour of the layer.

The “separation distance” is an item that can be set for the first support layer SL1 and the second support layer SL2, and is an item for designating a distance of a gap GP1 between the first support layer SL1 and the shaped object MD in a vertical direction and a distance of a gap GP2 between the second support layer SL2 and the shaped object MD in the vertical direction shown in FIG. 8. The separation distance represents a distance by which the nozzle 61 is separated from the top layer that is shaped during shaping. Therefore, no gap is formed in an actual shaped object, and the shaping material is ejected from above by a designated distance. The separation distance is not limited to an actual dimension, and may be designated by the number of layers.

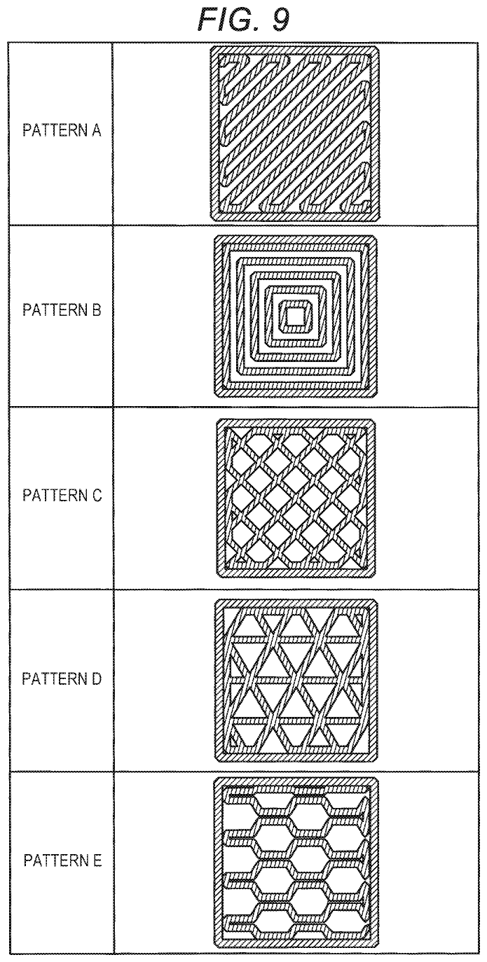

FIG. 9 is a diagram showing an example of the shaping pattern. In the present embodiment, different shaping patterns from a pattern A to a pattern E shown in FIG. 9 can be designated as the shaping patterns. The shaping patterns shown in FIG. 9 are all examples of shaping patterns provided inside a one-round contour. In the present embodiment, on the setting screen SS shown in FIG. 7, different shaping patterns are set as the shaping pattern for the first support layer SL1 and the shaping pattern for the second support layer SL2. For example, when the shaping pattern A is selected for the first support layer SL1, one of the shaping patterns B to E can be selected for the second support layer SL2. In another embodiment, the same shaping pattern may be set for the first support layer SL1 and the second support layer SL2.

FIG. 10 is a diagram showing the filling rate. FIG. 10 shows an example in which a filling rate of the shaping pattern A shown in FIG. 9 is changed between 90% and 50%. As shown in FIG. 10, the higher the filling rate, the narrower the spacing between the shaping materials forming the shaping pattern.

Among the shaping conditions shown in FIG. 7, items other than the shaping pattern may be omitted, and only the shaping pattern may be selectable from a plurality of patterns.

In step S30 in FIG. 6, the data generation unit 411 analyzes the shape data acquired in step S10 to determine a support region in which the support structure can be provided. Specifically, the data generation unit 411 sets a support region below the overhang portion of the shaped object. As described above, the overhang portion refers to a projection portion of the shaped object which is not supported below. In the present embodiment, the meaning of the overhang portion also includes a bridge portion. The bridge portion refers to a bridge-shaped portion whose both ends are supported in the shaped object.

In step S40, the data generation unit 411 generates shaping data including the main body data and the support data.

In generating the main body data, the data generation unit 411 analyzes the shape data acquired in step S10 and slices the shape of the shaped object MD into a plurality of layers along an XY plane. The data generation unit 411 generates movement path information representing a movement path of the nozzle 61 for forming the contour of each layer and filling the interior region with a predetermined filling rate or shaping pattern. The movement path information includes data representing a plurality of linear movement paths. Each movement path included in the movement path information includes ejection amount information representing an ejection amount of the shaping material ejected in the movement path. The data generation unit 411 generates the movement path information and the ejection amount information for all the layers of the shaped object MD to generate the main body data. The main body data is represented by, for example, a G code.

In generating the support data, the data generation unit 411 generates the support structure SC in which the first support layer SL1 and the second support layer SL2 are separated from the shaped object MD by the separation distance included in the shaping condition for the support region determined in step S30. The data generation unit 411 slices the first support layer SL1, the body layer BL, the second support layer SL2, and the base layer BS into a plurality of layers along the XY plane according to the lamination pitch and the number of layers included in the shaping condition. The data generation unit 411 generates movement path information for shaping the first support layer SL1, the body layer BL, the second support layer SL2, and the base layer BS according to the line width, the shaping pattern, the filling rate, and the number of rounds of the contour included in the shaping condition. Each movement path included in the movement path information includes ejection amount information representing an ejection amount of the shaping material ejected in the movement path. The data generation unit 411 generates the support data by generating the movement path information and the ejection amount information for all the layers of the support structure SC. The support data is represented by, for example, a G code, similar to the main body data.

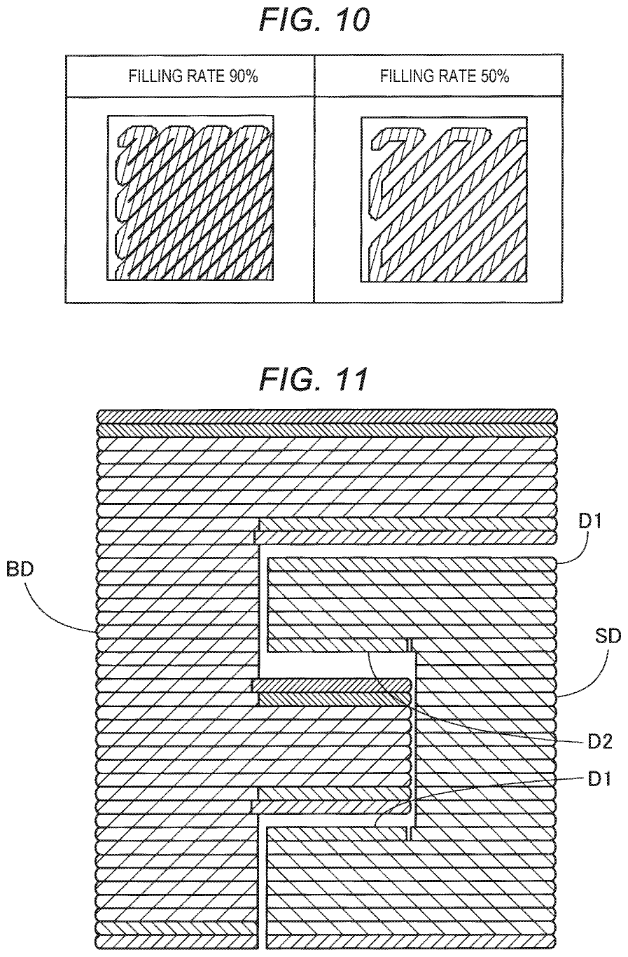

FIG. 11 is a diagram showing an example of visualizing the shaping data generated by the data generation unit 411. As shown in FIG. 11, the shaping data includes main body data BD for shaping the shaped object and support data SD for shaping the support structure SC. Among the support data SD, data D1 for shaping the first support layer SL1 and data D2 for shaping the second support layer SL2 are generated based on different shaping conditions, in the present embodiment, different shaping patterns.

In step S50 in FIG. 6, the control unit 300 of the three-dimensional shaping device 100 acquires, from the information processing device 400, the shaping data generated by the information processing device 400 in step S40 in FIG. 6.

In step S60, the control unit 300 shapes, according to the shaping data acquired from the information processing device 400, the shaped object MD and the support structure SC on the shaping surface 211 of the stage 210 by controlling the ejection unit 60 and the moving mechanism 230. In the support structure SC, the first support layer SL1 and the second support layer SL2 are shaped in different shaping patterns selected on the setting screen SS in FIG. 7. When the number of rounds of the contour is set to 1 or more on the setting screen in FIG. 7, the contour region is shaped, and the interior region is shaped inside the contour region according to the shaping pattern designated on the setting screen. When the number of rounds of the contour is 0, the contour region is not shaped, and only the interior region is shaped. In the present embodiment, the control unit 300 makes a shaping speed of the interior region higher than a shaping speed of the contour region. In the present embodiment, the shaping speed refers to a moving speed of the nozzle 61. The setting screen SS may be provided with items capable of setting the shaping speeds of the interior region and the contour region, respectively. Step S60 is also referred to as a first step.

In step S70, the support structure is separated from the shaped object. The support structure may be cut by a cutting device provided in the three-dimensional shaping device 100. Step S70 is also referred to as a second step.

According to the first embodiment described above, in the support structure SC, the first support layer SL1 in contact with the shaped object MD from below and the second support layer SL2 in contact with the shaped object MD from above are shaped by different shaping patterns. Therefore, by selecting a shaping pattern (for example, the shaping pattern C in FIG. 9) that easily supports the shaped object MD from below as the shaping pattern for shaping the first support layer SL1 and selecting a shaping pattern (for example, the shaping pattern A in FIG. 9) that easily separates from the shaped object MD as the shaping pattern for shaping the second support layer SL2, it is easy to achieve both the shaping accuracy of the shaped object MD and the peelability of the support structure SC from the shaped object MD.

In the present embodiment, as the shaping condition for shaping the support structure SC, in addition to the shaping pattern, at least one of (1) a condition related to the separation distance between the first support layer SL1 or the second support layer SL2 and the shaped object MD, (2) a condition related to the filling rates of the first support layer SL1 and the second support layer SL2, (3) a condition related to the lamination pitches of the first support layer SL1 and the second support layer SL2, (4) a condition related to the line widths of the first support layer SL1 and the second support layer SL2, and (5) a condition of the number of layers of the first support layer SL1 and the second support layer SL2 can be set. Therefore, the first support layer SL1 and the second support layer SL2 can be shaped under various different shaping conditions, and thus it is easy to achieve both the shaping accuracy of the shaped object MD and the peelability of the support structure SC. For example, the first support layer SL1 and the second support layer SL2 may have the same shaping pattern and different shaping conditions other than the shaping pattern, thereby achieving both the shaping accuracy of the shaped object MD and the peelability of the support structure SC.

In the present embodiment, since the first support layer SL1 or the second support layer SL2 can be shaped with the contour region and the interior region, the support structure SC can be easily separated from the shaped object MD along the contour region. For example, when the contour region is not formed in the support layer, the shaping pattern for shaping the interior region of the support layer may be brought into contact with the shaped object so as to bite into the shaped object. On the other hand, when the contour region is formed in the support layer, such biting can be prevented, and thus the support structure SC can be easily separated from the shaped object.

In the present embodiment, the shaping speed of the interior region is set to be higher than the shaping speed of the contour region during the shaping of the support structure SC. Therefore, a shaping time of the support structure SC can be shortened while ensuring the shaping accuracy of the contour region. In another embodiment, the shaping speed of the interior region and the shaping speed of the contour region may be the same speed, or the shaping speed of the interior region may be slower than the shaping speed of the contour region.

### B. Other Embodiments

(B1) In the first embodiment, various shaping conditions can be set on the setting screen SS shown in FIG. 7. On the other hand, the shaping conditions may be predetermined in the data generation unit 411 of the information processing device 400. In this case, shaping conditions capable of achieving both the shaping accuracy of the shaped object MD and the peelability of the support structure SC are predetermined by simulation or experiment. In this way, both the shaping accuracy of the shaped object and the peelability of the support structure can be appropriately ensured.

For example, by predetermining a filling rate of the second support layer SL2 to be smaller than a filling rate of the first support layer SL1, in step S40 in FIG. 6, the support data SD can be generated such that an adhesion strength between the second support layer SL2 and the shaped object MD is lower than an adhesion strength between the first support layer SL1 and the shaped object MD. When the adhesion strength between the second support layer SL2 and the shaped object MD is lower than the adhesion strength between the first support layer SL1 and the shaped object MD, the support structure SC can be easily peeled off from the second support layer SL2 in contact with the shaped object MD from below, and the shaped object MD can be easily supported by the first support layer SL1 in contact with the shaped object MD from above. Therefore, both the shaping accuracy of the shaped object MD and the peelability of the support structure SC from the shaped object MD can be achieved.

For example, by generating the support data SD such that a separation distance between the second support layer SL2 and the shaped object MD is greater than a separation distance between the first support layer SL1 and the shaped object MD in step S40 in FIG. 6, the adhesion strength between the second support layer SL2 and the shaped object MD can be lower than the adhesion strength between the first support layer SL1 and the shaped object MD. Therefore, the support structure SC can be easily peeled off from the second support layer SL2 in contact with the shaped object MD from below, and the shaped object MD can be easily supported by the first support layer SL1 in contact with the shaped object MD from above. As a result, both the shaping accuracy of the shaped object MD and the peelability of the support structure SC from the shaped object MD can be achieved.

In addition, for example, the adhesion strength between the second support layer SL2 and the shaped object MD can be made lower than the adhesion strength between the first support layer SL1 and the shaped object MD by making a line width of the second support layer SL2 larger than a line width of the first support layer SL1 or making a lamination pitch of the second support layer SL2 larger than a lamination pitch of the first support layer SL1.
(B2) In the first embodiment, in step S60 in FIG. 6, the three-dimensional shaping device 100 shapes the first support layer SL1 and the second support layer SL2 with a contour region and an interior region. On the other hand, the three-dimensional shaping device 100 may shape the contour region and the interior region for the first support layer SL1 or the second support layer SL2 having a portion in contact with the shaped object MD, and may shape only the interior region and not shape the contour region for at least one of the first support layer SL1, the second support layer SL2, the body layer BL, and the base layer BS of the support structure, which are not in contact with the shaped object MD.

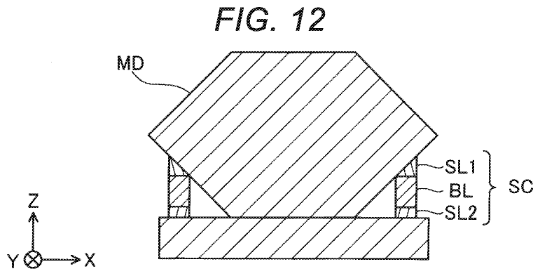

FIG. 12 is a diagram showing an example of the first support layer SL1 having a portion in contact with the shaped object MD and the second support layer SL2 not in contact with the shaped object MD. In the example shown in FIG. 12, since the first support layer SL1 has a portion in contact with the shaped object MD, the contour region and the interior region are shaped. On the other hand, since the second support layer SL2 is not in contact with the shaped object MD, only the interior region is shaped, and the contour region is not shaped. In this way, when the contour region is shaped for the support layer having a portion in contact with the shaped object MD, the support layer can be easily separated from the shaped object MD, and by not shaping the contour region for the support layer not in contact with the shaped object MD, a shaping time of the support structure SC can be shortened and the material consumption can be reduced. In the example shown in FIG. 12, the body layer BL of the support structure SC is also not in contact with the shaped object MD. Therefore, similar to the second support layer SL2, the shaping time can be further shortened by not shaping the contour region for the body layer BL.
(B3) Although the three-dimensional shaping device 100 according to the above-described embodiment includes one shaping unit 110, the three-dimensional shaping device 100 may include three shaping units 110. In this case, a shaping material for shaping the shaped object MD is ejected from the first shaping unit 110, a first support material is ejected from the second shaping unit 110, and a second support material is ejected from the third shaping unit 110. When the three-dimensional shaping device 100 includes a plurality of shaping units 110, the shaping condition may include a condition related to a material of the support layer. In this way, the first support layer SL1 and the second support layer SL2 can be shaped with different materials. For example, by shaping the first support layer SL1 with a material having high hardness and shaping the second support layer SL2 with a material having low hardness, both shaping accuracy and peelability of the support structure SC can be achieved. In the setting screen SS shown in FIG. 7, items for designating different materials for the first support layer SL1 and the second support layer SL2 may be provided. One of the first support layer SL1 and the second support layer SL2 may be shaped with a material same as a shaping material for forming the shaped object MD. In this case, at least two shaping units 110 may be provided in the three-dimensional shaping device 100.
(B4) In the above-described embodiment, the shaping unit 110 plasticizes a material by the flat screw 40. On the other hand, the shaping unit 110 may plasticize a material by, for example, rotating an inline screw. The shaping unit 110 may plasticize a filament-shaped material with a heater.
(B5) In the above-described embodiment, a material extrusion method in which plasticized materials are laminated is described as an example, but the present disclosure can be applied to various methods such as an ink-jet method, a direct metal deposition (DMD) method, and a binder jet method.

### C. Other Aspects

The present disclosure is not limited to the embodiments described above, and may be implemented by various configurations without departing from the scope of the present disclosure. For example, in order to solve a part or all of problems described above, or to achieve a part or all of effects described above, technical characteristics in the embodiments corresponding to technical characteristics in aspects to be described below can be replaced or combined as appropriate. Any of the technical features can be appropriately deleted unless the technical feature is described as essential herein.
(1) According to a first aspect of the present disclosure, a method for manufacturing a three-dimensional shaped object, in which a shaped object and a support structure that supports the shaped object are shaped by ejecting a material to laminate a layer in a laminating direction, is provided. The manufacturing method includes: a first step of shaping, based on support data generated according to a shaping condition, the support structure including a first support layer in contact with the shaped object from below and a second support layer in contact with the shaped object from above; and a second step of separating the first support layer and the second support layer from the shaped object, in which the shaping condition includes a shaping pattern selected from a plurality of shaping patterns, and data for shaping the first support layer and data for shaping the second support layer among the support data are generated based on the different shaping conditions.

According to such an aspect, the first support layer in contact with the shaped object from above and the second support layer in contact with the shaped object from below in the support structure can be shaped with different shaping patterns, and thus both the shaping accuracy of the shaped object and the peelability of the support structure from the shaped object can be easily achieved.
(2) In the above aspect, the shaping condition related to the support structure may include at least one of a condition related to a separation distance from the shaped object, a condition related to a filling rate, a condition related to a lamination pitch, a condition related to a line width, a condition related to the number of layers, and a condition related to a material. According to such an aspect, the first support layer and the second support layer can be shaped under various different shaping conditions, and thus both the shaping accuracy of the shaped object and the peelability of the support structure can be easily achieved.
(3) In the above aspect, the method may further include generating the support data such that an adhesion strength between the second support layer and the shaped object is lower than an adhesion strength between the first support layer and the shaped object. According to such an aspect, the support structure can be easily peeled off from the second support layer in contact with the shaped object from below, and the shaped object can be easily supported by the first support layer in contact with the shaped object from above. Therefore, both the shaping accuracy of the shaped object and the peelability of the support structure from the shaped object can be achieved.
(4) In the above aspect, the method may further include generating the support data such that a distance between the second support layer and the shaped object is larger than a distance between the first support layer and the shaped object in the laminating direction. According to such an aspect, the support structure can be easily peeled off from the second support layer in contact with the shaped object from below, and the shaped object can be easily supported by the first support layer in contact with the shaped object from above. Therefore, both the shaping accuracy of the shaped object and the peelability of the support structure from the shaped object can be achieved.
(5) In the above aspect, in the first step, the first support layer or the second support layer may be shaped with a contour region and an interior region. In such an aspect, the support structure can be easily peeled off from the shaped object by shaping the contour region.
(6) In the above aspect, in the first step, the first support layer or the second support layer may be shaped with a contour region and an interior region, and at least one layer of the support structure that is not in contact with the shaped object may be shaped with the interior region and without the contour region. According to such an aspect, since the support layer in contact with the shaped object is shaped with the contour region, the support layer can be easily peeled off from the shaped object, and since the layer not in contact with the shaped object is shaped without the contour region, the shaping time can be shortened.
(7) In the above aspect, a shaping speed of the interior region may be higher than a shaping speed of the contour region. According to such an aspect, a shaping time of the support structure can be shortened.
(8) According to a second aspect of the present disclosure, a three-dimensional shaping system is provided. The three-dimensional shaping system includes: a shaping unit configured to shape, by ejecting a material to laminate a layer in a laminating direction, a shaped object and a support structure that supports the shaped object; and a control unit configured to control the shaping unit to shape a first support layer in contact with the shaped object from below, a second support layer in contact with the shaped object from above, and the shaped object based on support data generated according to a shaping condition, in which the shaping condition includes a shaping pattern selected from a plurality of shaping patterns, and data for shaping the first support layer and data for shaping the second support layer among the support data are generated based on the different shaping conditions.
(9) According to a third aspect of the present disclosure, an information processing device is provided that generates support data used in a three-dimensional shaping device that shapes, by ejecting a material to laminate a layer in a laminating direction, a shaped object and a support structure that supports the shaped object. The information processing device includes: a data generation unit configured to generate, according to a shaping condition, the support data for shaping a first support layer in contact with the shaped object from below and a second support layer in contact with the shaped object from above, the shaping condition includes a shaping pattern selected from a plurality of shaping patterns, and the data generation unit is configured to generate, based on the different shaping conditions, data for shaping the first support layer and data for shaping the second support layer among the support data.

The present disclosure is not limited to the method for manufacturing a three-dimensional shaped object, the three-dimensional shaping system, and the information processing device, and can be implemented in various forms such as a computer program, and a non-transitory tangible recording medium in which a computer program is recorded in a computer-readable manner.

What is claimed is:

1. A method for manufacturing a three-dimensional shaped object, in which a shaped object and a support structure that supports the shaped object are shaped by ejecting a material to laminate a layer in a laminating direction, the method comprising:
a first step of shaping, based on support data generated according to a shaping condition, the support structure including a first support layer in contact with the shaped object from below and a second support layer in contact with the shaped object from above; and
a second step of separating the first support layer and the second support layer from the shaped object, wherein
the shaping condition includes a shaping pattern selected from a plurality of shaping patterns, and
data for shaping the first support layer and data for shaping the second support layer among the support data are generated based on the different shaping conditions.

2. The method for manufacturing a three-dimensional shaped object according to claim 1, wherein
the shaping condition related to the support structure includes at least one of a condition related to a separation distance from the shaped object, a condition related to a filling rate, a condition related to a lamination pitch, a condition related to a line width, a condition related to the number of layers, and a condition related to a material.

3. The method for manufacturing a three-dimensional shaped object according to claim 1, further comprising:
generating the support data such that an adhesion strength between the second support layer and the shaped object is lower than an adhesion strength between the first support layer and the shaped object.

4. The method for manufacturing a three-dimensional shaped object according to claim 1, further comprising:
generating the support data such that a distance between the second support layer and the shaped object is larger than a distance between the first support layer and the shaped object in the laminating direction.

5. The method for manufacturing a three-dimensional shaped object according to claim 1, wherein
in the first step, the first support layer or the second support layer is shaped with a contour region and an interior region.

6. The method for manufacturing a three-dimensional shaped object according to claim 1, wherein
in the first step, the first support layer or the second support layer is shaped with a contour region and an interior region, and at least one layer of the support structure that is not in contact with the shaped object is shaped with the inner region and without the contour region.

7. A method for manufacturing a three-dimensional shaped object according to claim 5, wherein
a shaping speed of the interior region is higher than a shaping speed of the contour region.
